(19) United States
(12) Patent Application Publication
(10) Pub. No.: US 2023/0034160 A1
(43) Pub. Date: Feb. 2, 2023

(54) SYSTEMS AND METHODS FOR CONTROLLING PEDAL FEEDBACK TO OPERATOR AND VEHICLE CONTROL

(71) Applicant: Toyota Research Institute, Inc., Los Altos, CA (US)

(72) Inventors: Manuel L. Kuehner, Mountain View, CA (US); Hiroshi Yasuda, San Francisco, CA (US)

(73) Assignee: Toyota Research Institute, Inc., Los Altos, CA (US)

(21) Appl. No.: 17/391,304

(22) Filed: Aug. 2, 2021

(51) Int. Cl. B60K 26/02; A43B 1/00

(52) U.S. Cl. CPC B60K 26/02; A43B 1/0054; B60K 2026/026

(57) ABSTRACT

Systems and methods are provided for controlling pedal feedback to an operator and vehicle control. One embodiment of a vehicle system includes a pedal having an engagement device configured to generate a pulling force on an operator device. The vehicle system also includes a controller configured to control the engagement device to generate the pulling force on the operator device. Embodiments also provide for electromagnetic and permanent magnet engagement devices, and control of engagement devices to engage an operator with a vehicle pedal. Embodiments also provide for multiple wearable configurations of operator devices for engaging with vehicle pedals. Processes are provided for activating and deactivating engagement devices in response to vehicle driving conditions.

### TECHNICAL FIELD

Embodiments described herein generally relate to vehicle systems and processes and, more specifically, to pedal feedback configurations and methods with control of feedback and vehicle control.

### BACKGROUND

Assistive driving features often incorporate vehicle control features. A key problem for control of vehicles, and especially for longitudinal control, is that the driving interfaces are limited in their ability to provide feedback to a driver. Some systems provide steering wheel control for lateral control (e.g., LCA) that include force applied in a clockwise and counterclockwise direction by the system. With longitudinal controls such as pedals, force feedback cannot pull an operator due to vehicle pedal configurations. Pedals can only apply a push force against a shoe sole but cannot apply a pull force. There exists a need and a desire for improved feedback systems for longitudinal control of vehicles.

### SUMMARY

Systems and methods for controlling pedal engagement are described. In one embodiment, a vehicle system includes an operator device, and a pedal including an engagement device, wherein the engagement device is configured to generate a pulling force on an operator device relative to the pedal. The vehicle system also includes a controller configured to control the engagement device to generate the pulling force on the operator device, wherein the controller activates the engagement device to generate the pulling force.

In one embodiment, the operator device is footwear including a sole, the sole including ferromagnetic material.

In one embodiment, the operator device is a wearable device including a ferromagnetic material.

In one embodiment, the pedal is a vehicle accelerator pedal.

In one embodiment, the engagement device is configured to generate a magnetic field to pull the operator device towards the pedal.

In one embodiment, the pulling force engages the operator device with a contact surface of the pedal.

In one embodiment, the controller is configured to control position of the pedal using a vehicle operating condition.

In one embodiment, the controller is configured to control the engagement device to deactivate the pulling force on the operator device.

In one embodiment, the controller is configured to detect an operating condition of a vehicle, and wherein control of the engagement device is in response to the operating condition.

In one embodiment, the vehicle system further includes a sensor configured to detect position of the operator device relative to the pedal.

In another embodiment, a vehicle system includes an operator device, and a pedal including an engagement device, wherein the engagement device is configured to generate a pulling force on an operator device relative to the pedal. The vehicle system also includes a controller configured to receive a vehicle operating condition, and control the engagement device to generate the pulling force on the operator device, wherein the controller activates the engagement device to generate the pulling force. The controller is also configured to control position of the pedal using a vehicle operating condition.

In one embodiment, the operator device is at least one of footwear including a sole, the sole including ferromagnetic material, and a wearable device including a ferromagnetic material.

In one embodiment, the pedal is a vehicle accelerator pedal.

In one embodiment, the pulling force engages the operator device with a contact surface of the pedal.

In one embodiment, the controller is configured to control the engagement device to deactivate the pulling force on the operator device.

In one embodiment, vehicle system also includes a sensor configured to detect position of the operator device relative to the pedal.

In yet another embodiment, a method for controlling a pedal engagement device of a vehicle system is provided. The method includes receiving, by a controller, a vehicle operating characteristic, and controlling, by the controller, an engagement device to generate a pulling force on an operator device, wherein the controller activates the engagement device to generate the pulling force. The method also includes updating, by the controller, output of to the engagement device.

In one embodiment, the vehicle operating characteristics is associated with vehicle control of pedal position.

In one embodiment, the controller controls the engagement device to generate a magnetic field to pull the operator device towards a pedal.

In one embodiment, updating includes controlling the engagement device to deactivate the pulling force on the operator device.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a vehicle system, according to embodiments described herein;

FIGS. 2A-2C depict pedal configurations, according to embodiments described herein;

FIGS. 3A-3B depict operator devices, according to embodiments described herein;

FIG. 4 depicts a graphical representation of a system for controlling a pedal device, according to embodiments described herein; and

FIG. 5 depicts a graphical representation of a process for controlling a pedal device, according to embodiments described herein.

### DETAILED DESCRIPTION

Embodiments disclosed herein include systems and methods for pedal engagement. Some embodiments include processes for controlling a pedal engagement. The systems and methods for controlling a pedal engagement will be described in more detail, below.

Conventional pedals can control a vehicles longitudinal direction. However, these systems do not rely on providing feedback to a user other than spring tension in pedal return. With vehicle systems that allow for control of pedal position, use of a conventional pedal also does not provide feedback as the pedal pad does not engage an operator's foot. There is a desire for feedback to an operator when pedal position is controlled by a vehicle. Embodiments provide mechanisms and configures to engage an operator, and in particular, a portion association with an operators foot to a pedal. According to embodiments, configurations are provided for magnetic engagement. Pedal configurations are provided including one or more of electromagnetics and permanent magnets. Embodiments are also provided for use of inductive elements to generate magnetic fields for pedal engagement. Systems and configurations described herein also provide for operator devices that may be worn by an operator. Operator devices may include ferromagnetic material in a wearable form, such as footwear or a banded device. System configurations and methods are also provided for controlling an engagement device of a pedal in association with longitudinal feedback for vehicles. By way of example, electromagnetic fields may be controlled or varied to engage and release an operator device. Electromagnetic fields may also be controlled to repel an operator device. By providing engagement mechanisms and control, an operator may feel controls of a pedal by a vehicle. As such, pedal feedback is provided to the operator and the operator can be notified of vehicle operations. In addition to notifying a vehicle operator, tactile feedback is provided to a user that may be perceived without requiring the use of a display or additional interface.

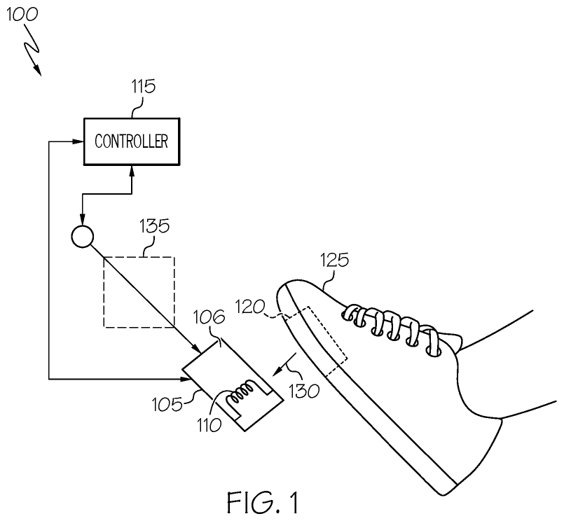

Referring now to the drawings, FIG. 1 depicts a non-limiting vehicle system 100, according one or more embodiments. The example vehicle system 100 includes components of a vehicle to provide pedal engagement. Vehicle system 100 may be configured to operate with one or more systems and components of a vehicle to control engagement of a pedal with a vehicle operator. Vehicle system 100 may provide operator feedback in connection with longitudinal control of a vehicle. By way of example, system 100 can provide bidirectional haptic communication between an operator of a vehicle (e.g., driver) and a vehicle by way of a vehicle control pedal. Vehicle system 100 can provide pulling feedback. Pulling feedback can include an attraction force generated between a pedal pad and the sole of a shoe. According to embodiments, vehicle system 100 also provides a solution for directional feedback and for shared longitudinal control in that a driving interface, such as a pedal, to provide feedback for a pushing force feedback and a pulling force feedback (i.e., the pedal can push against a foot and pull a foot).

As shown in FIG. 1, example vehicle system 100 includes pedal 105 including pedal feedback element 110. Pedal feedback element 110 may be controlled by a controller 115 to generate a pulling force for operator device 120, the pulling force shown as 130 in FIG. 1. According to embodiments, pulling force 130 may be controlled to engage an operator, such as an operator foot 125 with surface 106 of pedal 105. By engaging the operator device 120 associated with operator foot 125, a driver may be notified and provided with feedback of vehicle system 100 operations that pull a vehicle pedal, such as pedal 105. In an assistive driving scenario, such as collision avoidance, a vehicle system may determine that increase speed of the vehicle is required which result in control of the vehicle accelerator pedal being pulled away from an operator. By way of example, vehicle system operations can include lane change assist, highway entry, and increases in speed in general.

According to embodiments, pedal 105 is a vehicle control pedal, such as an accelerator pedal to control longitudinal operation of a vehicle, such as an automobile. According to other embodiments, pedal 105 is a brake pedal. Activation of pedal 105 by an operator, such as depression or release may be detected by controller 115. Pedal 105 may include surface 106 for contact by the operator. Surface 106 is a pedal surface and may be a substantially flat or planar surface of a pedal pad. Pedal 105 is shown as a pedal pad including pedal feedback element 110. According to embodiments, pedal feedback element 110 may be integrated with a pedal pad of pedal 105.

According to embodiments, pedal feedback element 110 is an engagement device. Pedal feedback element 110 may generate a pulling force on operator device 120 relative to pedal 105. Pedal feedback element 110 may include material or objects that produce a magnetic field. Magnetic fields generated by pedal feedback element 110 may be invisible while exhibiting properties of a magnet, such as a force that pulls on or repels other ferromagnetic materials, including but not limited to as iron, steel, nickel, cobalt, etc. In embodiments, pedal feedback element 110 is a magnetic device configured to generate a magnetic field to attract and engage ferromagnetic materials. According to other embodiments, pedal feedback element 110 may be an inductive device configured to generate a magnetic field. Pedal feedback element 110 may be configured to generate pull force 130 to pull operator device 120 in contact with pedal surface 106. Pedal feedback element 110 can be an electromagnet that can vary a magnetic field.

Pull force 130 may engage operator foot 125 with pedal surface 106 when pedal 105 is pulled away from the operator due to longitudinal controls of the vehicle. According to embodiments, pedal feedback element 110 may also be configured to detect contact of operator device 120 with pedal surface 106. By way of example, pedal feedback element 110 may be controlled to operate as magnetic sensor. By way of further example, pedal feedback element 110 may use coil as a sensor by measuring magnetic field or inductance and identify presence when a ferromagnetic material is present.

According to embodiments, vehicle system 100 can utilize a wearable item, such as a shoe, having an attraction to magnetic fields. Vehicle system 100 can also include a pedal 105 configured to generate a magnetic field to provide a pulling force to the wearable. According to embodiments, the pulling force complements a pushing force found in pedals to provide a bidirectional haptic communication between the driver and the system in shared longitudinal control systems.

According to embodiments, vehicle system 100 includes pedal feedback element 110 configured to operate with one or more types of operator devices. According to embodiments, operator device 120 may be part of footwear including a sole, the sole including ferromagnetic material, as operator device 120. According to other embodiments, operator device 120 may be a wearable device including a ferromagnetic material. When vehicle system 100 activates pedal feedback element 110, a pulling force, such as a magnetic field, may be generated to pull operator device 120 towards pedal 105 and to engage operator device 120 with contact surface 106, such as a pedal pad, of the pedal 105.

According to embodiments, controller 115 is configured to control the engagement device 110 to generate pulling force 130 on operator device 120. Controller 115 may activate the engagement device 110 to generate pulling force 130. Controller 115 may also be configured to control position of pedal 105. Control of pedal position may be based on vehicle operating conditions. By engaging the operator, such as the operator foot with pedal surface 106, feedback may be provided to the vehicle operator when the pedal position is controlled by controller 115. Controller 115 may also deactivate the engagement device 110 to remove pulling force 130. Control of engagement device 110 by controller 115 may be based on one or more detected operating conditions of a vehicle. As discussed with reference to FIG. 5, control of the engagement device may be in response to the operating condition such that controller 115 may activate and/or deactivate based on one or more driving conditions or detected scenarios.

According to embodiments, vehicle system 100 includes sensor 135 configured to detect the position of pedal 105. According to embodiments, sensor 135 may be configured to detect position of the operator device 120 relative to the pedal. By detecting position of operator device 120, vehicle system 100 may determine actions for control. Sensor 135 may detect presence of an operator relative to pedal 105 based on force to pedal 105, a physical button (not shown in FIG. 1) on pedal surface 106, capacitive detection and optical detection of operator foot 125.

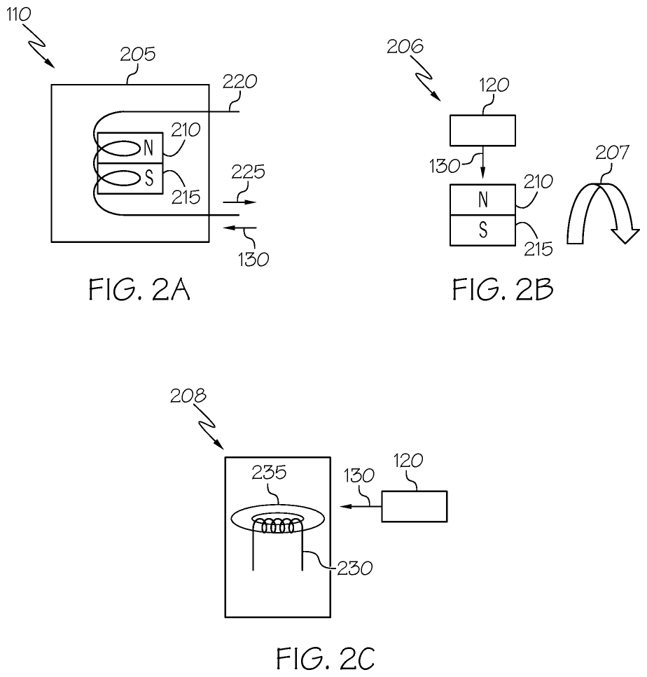

FIGS. 2A-2B depict pedal configurations for engagement devices (e.g., engagement device 110), according to embodiments described herein. FIG. 2A shows an electromagnetic engagement device configuration including structure 205 housing poles 210, 215 (e.g., north and south poles), and winding 220. A control device (e.g., controller 115) may be configured to activate the engagement device by applying current to winding 220. According to embodiments, activation of engagement device can generate pull force 130. In embodiments, inversion of polarity applied to winding 220 may generate a repelling force 225. As such, FIG. 2A illustrates a pedal feedback element to operate push and pull haptic forces to feet/pedals in an electromagnet configuration. The magnetic field, generated by or included with the engagement devices, allows the system to apply a pulling force on the driver's foot when the pedal is moving away from the foot. According to embodiments, the combination of the pulling force and the pushing force may form a bidirectional haptic communication between a driver and vehicle system 100 for longitudinal control systems.

FIG. 2B illustrates a pedal feedback element 206 as a permanent magnet configuration with magnetic poles 210, 215 to generate pulling force 130 for attracting operator device 120. According to embodiments, one or more of the position and orientation of pole elements 210, 215 may be adjusted. According to embodiments, pedal feedback element 206 may be rotated, as shown by direction 207, to deactivate pulling force 130. According to embodiments, pole elements 210, 215 may be poles of a permanent magnet that may be rotatable arranged in a housing or structure. The housing may hold in at least a first position such that polarity of the magnetic field attracts ferromagnetic materials, such as an operator device 120. The housing may be configured to allow pole elements 210, 215 to rotate to a position where the generated field does not attract ferromagnetic materials, such as an operator device 120. FIG. 2C illustrates a pedal feedback element 208 including an inductive element 230 configured to generate field 235 which may be activated to generate pulling force 130 and engagement of operator device 120.

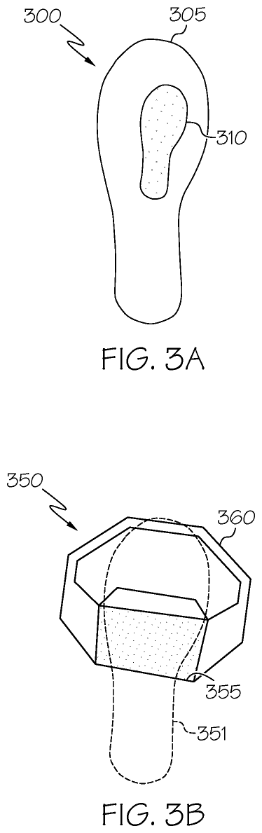

FIGS. 3A-3B depict operator devices, according to embodiments. FIG. 3A illustrates operator device 300 as a shoe including a sole 305 and ferromagnetic material 310. According to elements, ferromagnetic material 310 may be embedded in sole 305 of a shoe or footwear to provide material that can be engagement with a vehicle pedal. By way of example, a driver may wear a special shoe that can be attracted to magnetic fields and the vehicle may be equipped with a pedal, such as pedal 105, having a means for creating a magnetic field. According to embodiments, sole 305 may have iron, and one or more vehicle pedals may have a permanent magnet or electromagnet.

FIG. 3B illustrates operator device 350 as a wearable element having ferromagnetic material 355 and band 360. Band 360 may fit over a vehicle operator's foot or shoe, shown as 351, and hold ferromagnetic material 355 in position with respect to the operator's foot. When engaged with a pedal, ferromagnetic material 355 and band 360 may engage a driver's foot to a pedal. Ferromagnetic material 355 may be a pad or thin plate of material configured to engage with a pedal and be retained by the pedal when a magnetic field is present. Ferromagnetic material 355 may include a planar surface for contacting an engagement device.

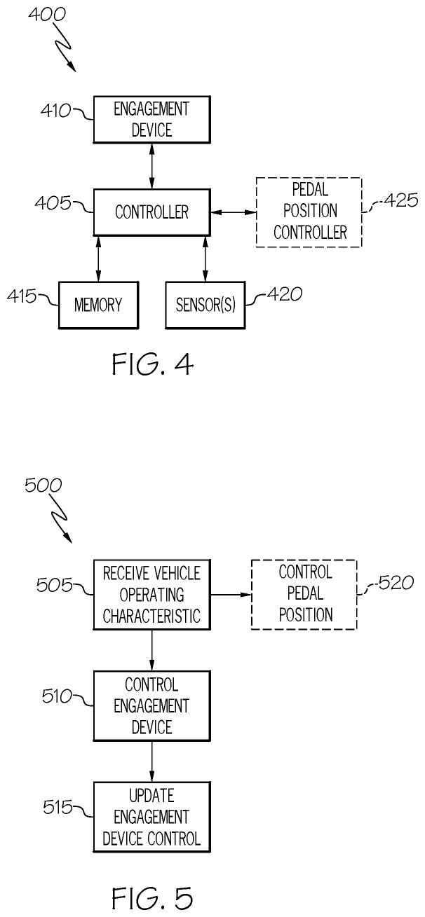

FIG. 4 depicts a graphical representation of a system for controlling a pedal device, according to embodiments described herein. According to one embodiment, system 400 may include one or more components for controlling pedal engagement. System 400 includes controller 405, engagement device 410, memory 415 and at least one sensor 420. Engagement device 410 may be embedded in or part of a vehicle pedal (e.g., pedal 105). According to one embodiment, system 400 may be employed by or configured as a vehicle system, such as vehicle system 100 of FIG. 1.

Controller 405 may relate to a processor or control device configured to execute one or more operations stored in memory 415, such as processes for controlling an vehicle pedal engagement device. Controller 405 may be coupled to memory 415, sensors 420 and engagement device 410. Controller 405 may be configured to control activation of engagement device 410 based on one or more inputs from sensors 420 and vehicle driving conditions. Controller 405 may receive indications of driving conditions from operation pedal position controller 425 which may be part of a vehicles assistive or autonomous driving services for control of pedal position.

Controller 405 may be configured to control engagement device 410 to generate a pulling force on an operator device (e.g., operator device 120) relative to the pedal (e.g., pedal 105). Controller 405 may be configured to receive a vehicle operating conditions, and control engagement device 410 to generate the pulling force on the operator device. Controller 405 may activate engagement device 410 to generate the pulling force, and control position of the pedal using a vehicle operating condition.

FIG. 5 depicts a graphical representation of a process for controlling a pedal device, according to embodiments described herein. Process 500 may be performed by a vehicle system (e.g., vehicle system 100) and/or devices as described herein. Process 500 may be initiated by receiving a vehicle operating characteristics at block 505. Vehicle operating characteristics can include vehicle driving modes, such as assistive or automated driving wherein the vehicle controls pedal position. By way of example, an assistive driving condition may include detection by a vehicle of the need to increase speed, wherein the pedal position is adjusted to reflect vehicle acceleration. Without engagement, a vehicle operator may not have a foot engaged with the pedal. As such, vehicle operating characteristics may be associated with vehicle control of pedal position.

Similarly, in an evasive driving scenario, a vehicle can detect a foot pulling back from a pedal and the vehicle may override control to cause pedal to stay in position. Other scenarios of driving conditions may include approaching a traffic light or entering a highway where speed may need to be maintained or increased. Based on received vehicle operating characteristics and driving scenarios, a controller may (e.g., controller 115) may be configured to control an engagement device at block 510. Control at block 510 may include control of an engagement device to generate a magnetic field to pull the operator device towards a pedal. Control at block 510 may be for an engagement device to generate a pulling force on an operator device, wherein the controller activates the engagement device to generate the pulling force. Process 500 may optionally include controlling pedal position at block 520. Control at optional block 520 may be coordinated with control of an engagement device at block 510. According to an exemplary embodiment, control at block 510 and optional block 520 may be based on an assistive driving scenario, such as collision avoidance, wherein increased speed of the vehicle is required. In such a case, control of the vehicle accelerator pedal at block 520 can include the pedal being pulled away from an operator, with an operator engaged with the pedal. Other examples of pulling scenarios of a pedal can include lane change assist, highway entry, and increases in speed in general.

At block 515, the controller may update engagement device control to deactivate the pulling force on the operator device.

As illustrated above, various embodiments for vehicle systems and processes for providing pedal engagement are provided. Vehicle systems can include a pedal having a pedal feedback element that may be controlled to engage with an operator device. The pedal feedback element can provide operator feedback in connection with longitudinal control of a vehicle. Embodiments provide pedal engagement configurations, operator device configurations, and control of pedal engagement. Pedal engagement configurations can include electromagnetic and permanent magnets to generate magnetic fields. The electromagnets may be controlled to activate, deactivate and vary magnetic fields. Permanent magnets may be repositioned to provide magnetic fields. In addition to pedal engagement configurations, vehicle system control may be provided to control engagement and pedal position in response to driving situations or scenarios. A vehicle control system may control pedal position and coordinate engagement of an operator with control of pedal position. As such, embodiments provide configurations for bidirectional feedback to operators of a vehicle.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for haptic array devices. It should also be understood that these embodiments are merely exemplary and are not intended to limit the scope of this disclosure.

What is claimed is:

1. A vehicle system comprising:
an operator device;
a pedal including an engagement device, wherein the engagement device is configured to generate a pulling force on an operator device relative to the pedal; and
a controller configured to control the engagement device to generate the pulling force on the operator device, wherein the controller activates the engagement device to generate the pulling force.

2. The vehicle system of claim 1, wherein the operator device is footwear including a sole, the sole including ferromagnetic material.

3. The vehicle system of claim 1, wherein the operator device is a wearable device including a ferromagnetic material.

4. The vehicle system of claim 1, wherein the pedal is a vehicle accelerator pedal.

5. The vehicle system of claim 1, wherein the engagement device is configured to generate a magnetic field to pull the operator device towards the pedal.

6. The vehicle system of claim 1, wherein the pulling force engages the operator device with a contact surface of the pedal.

7. The vehicle system of claim 1, wherein the controller is configured to control position of the pedal using a vehicle operating condition.

8. The vehicle system of claim 1, wherein the controller is configured to control the engagement device to deactivate the pulling force on the operator device.

9. The vehicle system of claim 1, wherein the controller is configured to detect an operating condition of a vehicle, and wherein control of the engagement device is in response to the operating condition.

10. The vehicle system of claim 1, further comprising a sensor configured to detect position of the operator device relative to the pedal.

11. A vehicle system comprising:
an operator device;
a pedal including an engagement device, wherein the engagement device is configured to generate a pulling force on an operator device relative to the pedal; and
a controller configured to
receive a vehicle operating condition,
control the engagement device to generate the pulling force on the operator device, wherein the controller activates the engagement device to generate the pulling force, and
control position of the pedal using a vehicle operating condition.

12. The vehicle system of claim 11, wherein the operator device is at least one of footwear including a sole, the sole including ferromagnetic material, and a wearable device including a ferromagnetic material.

13. The vehicle system of claim 11, wherein the pedal is a vehicle accelerator pedal.

14. The vehicle system of claim 11, wherein the pulling force engages the operator device with a contact surface of the pedal.

15. The vehicle system of claim 11, wherein the controller is configured to control the engagement device to deactivate the pulling force on the operator device.

16. The vehicle system of claim 11, further comprising a sensor configured to detect position of the operator device relative to the pedal.

17. A method for controlling a pedal engagement device of a vehicle system, the method comprising:
receiving, by a controller, a vehicle operating characteristic;
controlling, by the controller, an engagement device to generate a pulling force on an operator device, wherein the controller activates the engagement device to generate the pulling force;
and
updating, by the controller, output of the engagement device.

18. The method of claim 17, wherein the vehicle operating characteristics is associated with vehicle control of pedal position.

19. The method of claim 17, wherein the controller controls the engagement device to generate a magnetic field to pull the operator device towards a pedal.

20. The method of claim 17, wherein updating includes controlling the engagement device to deactivate the pulling force on the operator device.
